(19) United States
(12) Patent Application Publication
(10) Pub. No.: US 2010/0051754 A1
(43) Pub. Date: Mar. 4, 2010

(54) Aircraft

(76) Inventor: Robert M. Davidson, Saskatoon (CA)

Correspondence Address: ADE & COMPANY INC., 2157 Henderson Highway, WINNIPEG, MB, R2G1P9, CA

(21) Appl. No.: 12/198,940

(22) Filed: Aug. 27, 2008

(51) Int. Cl. B64C 39/00; B64C 21/04

(52) U.S. Cl. 244/23 C; 244/23 D

(57) ABSTRACT

An aircraft has a generally circular main body including an upper surface portion supported for rotation about a central passenger compartment to produce a gyroscopic effect on the aircraft. The rotatable upper surface portion includes viewable panes therein arranged to provide visibility therethrough from the central passenger compartment to an exterior of the main body. An engine communicates between a central inlet opening in the upper surface portion and an exhaust opening in the bottom of the main body to provide upward thrust to the aircraft.

This application claims foreign priority benefits from Canadian Patent Application X,XXX,XXX, filed Aug. 6, 2008.

### FIELD OF THE INVENTION

The present invention relates to an aircraft having a generally circular main body in which an upper surface portion of the main body is supported for rotation about a central passenger compartment to produce a gyroscopic effect on the aircraft, and more particularly the present invention relates to an aircraft in which the rotatable upper surface portion includes viewable panes therein arranged to provide visibility therethrough from the central passenger compartment to an exterior of the main body.

### BACKGROUND

The design of aircraft which is stable in-flight yet remains highly manoeuvrable and makes efficient use of power is known to be desirable. Various attempts at designing improved aircraft are disclosed in the following prior US patents. U.S. Pat. No. 5,213,284 belonging to Webster; U.S. Pat. No. 5,259,571 belonging to Blazquez; U.S. Pat. No. 4,807,830 belonging to Horton; U.S. Pat. No. 2,935,275 belonging to Grayson; U.S. Pat. No. 5,064,143 belonging to Bucher and U.S. Pat. No. 5,072,892 belonging to Carrington.

Some attempts to improve stability of aircraft in the prior art include the use of rotating auxiliary masses on the aircraft body to provide a gyroscopic effect. The use of such additional masses however decreases the overall efficiency of the aircraft due to the extra power being lost to lift the auxiliary mass against the force of gravity.

Further attempts to improve aircraft according to the prior art include the use of vertical thrust fans for improving manoeuvrability and vertical take-off ability, however such known attempts generally have a negative effect on the overall aerodynamics of the body of the aircraft during horizontal flight resulting in a loss in efficiency in propelling the vehicle in a forward lateral motion.

### SUMMARY OF THE INVENTION

According to one aspect of the invention there is provided an aircraft comprising:

a main body comprising an upper surface portion spanning a top side of the main body generally radially outward from an inlet opening centrally located in the top side of the main body to a generally circular outer periphery of the main body and a lower surface portion spanning a bottom side of the main body opposite the upper surface portion;

a passenger compartment centrally located in the main body between the upper surface portion and the lower surface portion and being arranged to receive at least one passenger therein;

an engine duct communicating through the main body between the inlet opening centrally located in the upper surface portion of the main body above the passenger compartment and an exhaust opening in the lower surface portion of the main body; and

an engine supported in the engine duct in communication between the inlet opening and the exhaust opening and arranged to provide upward thrust to the main body;

the upper surface portion being supported for rotation relative to the passenger compartment and the engine; and

the upper surface portion of the main body having a suitable mass relative to the aircraft so as to be arranged to produce a gyroscopic effect on the aircraft.

According to a second aspect of the present invention there is provided an aircraft comprising:

a main body comprising an upper surface portion spanning a top side of the main body generally radially outward from an inlet opening centrally located in the top side of the main body to a generally circular outer periphery of the main body and a lower surface portion spanning a bottom side of the main body opposite the upper surface portion;

a passenger compartment centrally located in the main body between the upper surface portion and the lower surface portion and being arranged to receive at least one passenger therein;

an engine duct communicating through the main body between the inlet opening centrally located in the upper surface portion of the main body above the passenger compartment and an exhaust opening in the lower surface portion of the main body; and

an engine supported in the engine duct in communication between the inlet opening and the exhaust opening and arranged to provide upward thrust to the main body;

the upper surface portion including a plurality of viewing panes therein arranged to provide visibility therethrough from the passenger compartment to an exterior of the main body; and

the upper surface portion being supported for rotation relative to the passenger compartment and the engine.

By providing a portion of the aircraft body itself which rotates, a gyroscopic effect can be produced to improve stability of the aircraft without the necessity of auxiliary masses which would otherwise reduce efficiency of the vehicle. Furthermore by arranging a portion of the body to rotate which comprises an upper surface spanning from a central opening to the periphery, the aerodynamics of the aircraft body are maintained in an optimal manner for optimum efficiency when the aircraft is displaced horizontally through the air. Vertical thrust may further be provided in communication through the central opening about which the upper surface rotates to take advantage of the improved manoeuvrability of vertical thrust while maintaining the body of the aircraft in a suitable aerodynamic shape to provide lift when displaced in a horizontal direction.

By further providing viewing panes in the rotating portion of the body, visibility can be maintained for passengers in a central passenger compartment again without sacrificing an ideal aerodynamic shape of the body and without requiring unnecessary auxiliary masses to be rotated to provide a stable gyroscopic effect on the aircraft.

The upper surface portion and the lower surface portion are preferably suitably shaped to produce lift when displaced through the air in a lateral direction.

In one embodiment, the lower surface portion of the housing is arranged to be fixed relative to the passenger compartment.

Alternatively, the lower surface portion of the housing may be arranged to rotate relative to the passenger compartment in an opposing direction relative to the upper surface portion.

The exhaust opening may comprise a central exhaust opening centrally located in the lower surface portion. In this instance, the engine duct preferably extends vertically between the inlet opening in the upper surface portion and the central exhaust opening in the lower surface portion and the engine preferably comprises a jet engine supported in the engine duct between the inlet opening and the central exhaust opening.

There may be provided a steering mechanism arranged to redirect exhaust from the engine exiting through the central exhaust opening in which the steering mechanism comprises an actuator arranged to redirect a portion of the exhaust through the central exhaust opening in a lateral direction. The actuator may be supported for rotation in a circumferential direction about the central exhaust opening to vary orientation of the lateral direction relative to the passenger compartment.

Alternatively, the exhaust opening may comprise an annular exhaust opening. In this instance, the engine preferably comprises a pair of annular fan members supported for rotation in proximity to the exhaust opening and the engine duct preferably communicates through an annular space between the passenger compartment and the upper surface portion of the main body from the central inlet opening above the passenger compartment to the annular fan members below the passenger compartment. The engine may further include a jet engine centrally supported on the main body and arranged to provide thrust in a lateral direction.

In a further embodiment, the exhaust opening may comprise both a central exhaust opening centrally located in the lower surface portion and an annular exhaust opening about the central exhaust opening.

In this instance the engine preferably comprises both: (a) a jet engine supported in a central portion of the engine duct between the inlet opening and the central exhaust opening; and (b) a pair of annular fan members supported for rotation in proximity to the exhaust opening and arranged for communication through an annular portion of the engine duct comprising an annular space between the passenger compartment and the upper surface portion of the main body from the central inlet opening above the passenger compartment to the annular fan members below the passenger compartment.

When there is provided an outer wall surrounding the passenger compartment in fixed relation to the passenger compartment, the outer wall preferably includes a plurality of viewing panes supported therein in which the viewing panes in the outer wall are arranged for alignment with the viewing panes in the upper surface portion of the main body as the upper surface portion of the main body is rotated.

There may be provided a fuel tank arranged to provide fuel to the engine which is supported centrally on the main body below the passenger compartment in fixed relation to the passenger compartment.

When the plurality of viewing panes are circumferentially spaced about the inlet opening, the upper surface portion between adjacent ones of the viewing panes may be near in width in the circumferential direction to a width of the viewing panes in the circumferential direction without substantial loss in visibility due to the rotation of the upper surface portion about the passenger compartment.

Some embodiments of the invention will now be described in conjunction with the accompanying drawings in which:

### BRIEF DESCRIPTION OF THE DRAWINGS

FIG. 1 is a side elevational view of a first embodiment of the aircraft.

FIG. 2 is a sectional view along the line 2-2 of FIG. 1.

FIG. 3 is a perspective view of some of the internal components of the aircraft according to FIG. 1.

FIG. 4 is a perspective view of the central steering mechanism of FIG. 1.

FIG. 5 is a plan view of the central steering mechanism of FIG. 4.

FIG. 6 is a perspective view of an alternative configuration of the central steering mechanism.

FIG. 7 is a schematic representation of a second embodiment of the aircraft.

FIG. 8 is a schematic plan view of a set of gears used in the embodiment of FIG. 7.

FIG. 9 is a perspective view of a further embodiment of the aircraft.

FIG. 10 is a partly sectional elevational view of the aircraft of FIG. 9.

FIG. 11 is a partly sectional plan view of the aircraft of FIG. 9.

FIG. 12 is a side elevational view of the primary steering mechanism of the aircraft of FIG. 9.

In the drawings like characters of reference indicate corresponding parts in the different figures.

### DETAILED DESCRIPTION

Referring to the accompanying figures there is illustrated an aircraft generally indicated by reference numeral 10. The aircraft is well suited for vertical takeoff and landing while further having a body suitably shaped for providing lift when displaced horizontally through the air in a stable manner by taking advantage of a gyroscopic effect of rotating components of the aircraft.

Although various embodiments are described in the following, some of the common features of the aircraft 10 will first be described herein.

The aircraft includes a main body 12 including an upper surface portion 14 which spans a top side of the body and a lower surface portion 16 which spans the bottom side of the body.

The upper surface portion 14 extends generally radially outward from a central inlet opening 18 centrally located in the top side of the aircraft to an outer periphery 20 of the aircraft which is generally circular in shape. The upper surface portion 14 is smooth and continuous and has a generally domed shaped which is circular when viewed from above.

The lower surface portion 16 is flatter than the upper surface portion and spans across the bottom side of the aircraft to join the upper surface portion about the periphery 20 thereof where the upper surface portion 14 overlaps downwardly over the outer peripheral edge of the lower surface portion. The upper and lower surface portions together enclose a hollow interior of the main body arranged to receive a passenger compartment 22 therein. The upper and lower surface portions together form a suitable shape which is arranged to provide lift to the aircraft when displaced horizontally through the air.

The passenger compartment 22 is centrally located between the upper surface portion and the lower surface portion within the interior of the body of the aircraft. The compartment 22 is suitably arranged to receive a plurality of persons therein including passengers, crew and the like as well as suitable cargo as may be desired. The passenger compartment includes an outer wall 24 which is generally domed in shape so as to be similar in shape and profile to the upper surface portion 14 of the main body thereabove. The passenger compartment 22 is smaller in dimension than the upper surface portion 14 of the main body so as to define an annular space 26 around and above the outer wall 24 of the passenger compartment between the outer wall 24 and the upper surface portion 14 of the main body.

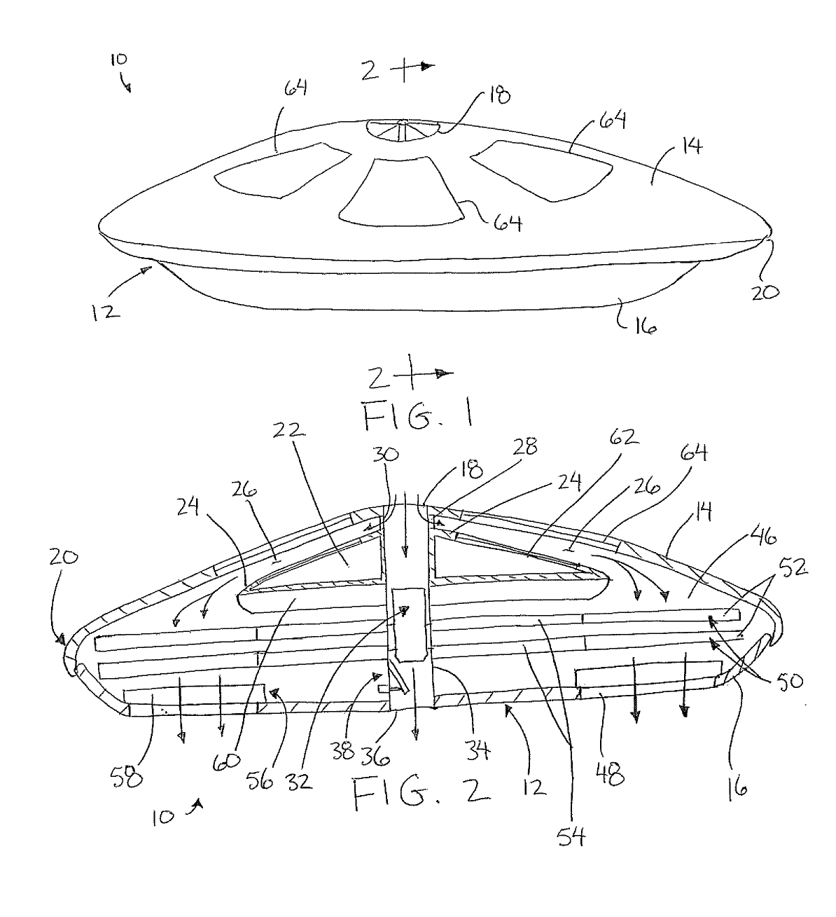

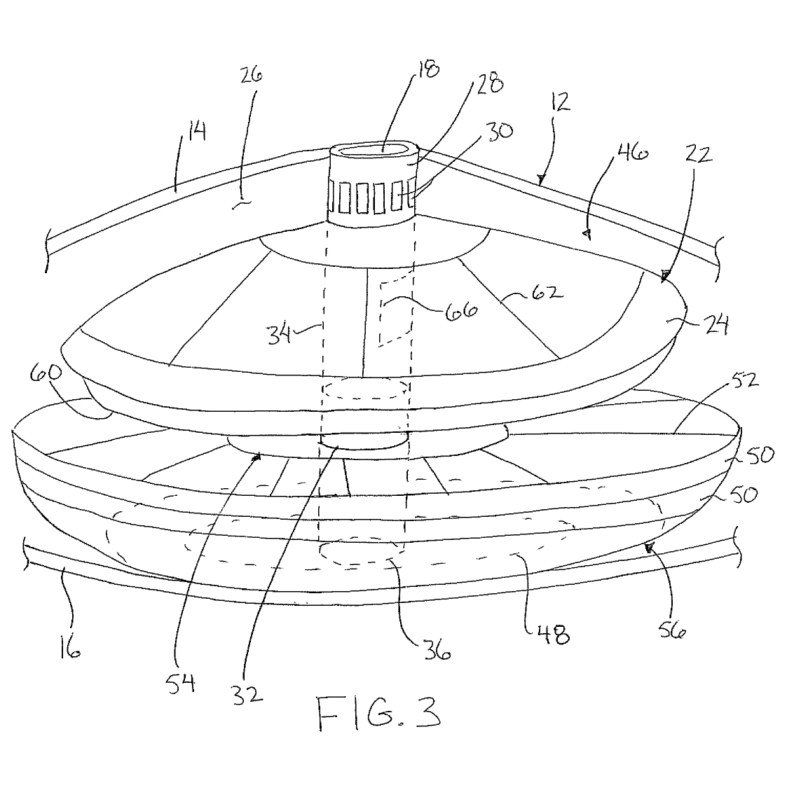

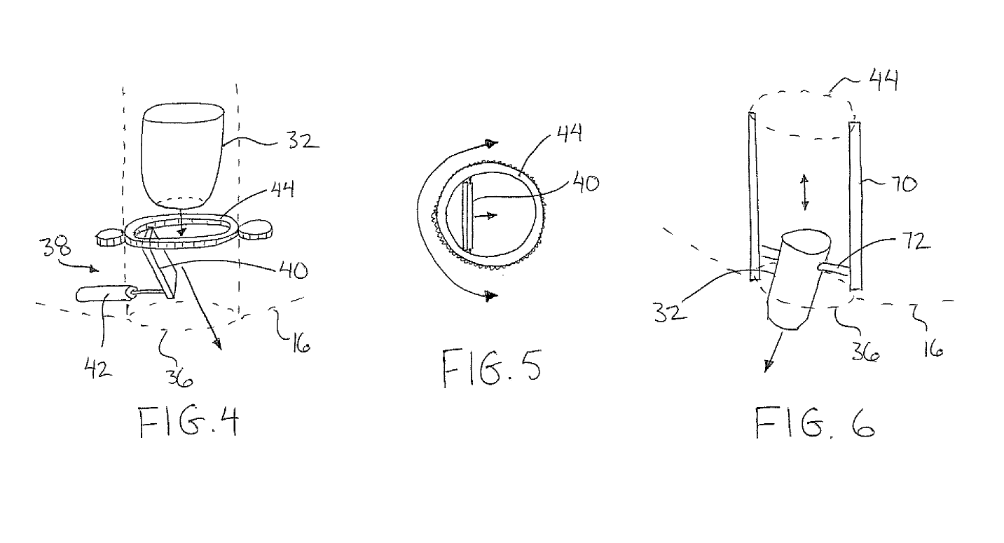

Referring initially to FIGS. 1 through 4, there is provided a collar 28 extends downwardly from the inlet opening 18 to the outer wall 24 to span the space between the upper surface portion and the passenger compartment centrally at the top side of the aircraft. A plurality of circumferentially spaced openings 30 in the collar 28 communicate between the inlet opening and the annular space 26 within the hollow interior of the body.

The passenger compartment 22 is fixed relative to the lower surface portion 12 while the upper surface portion 14 is arranged to be rotated relative to the lower surface portion and the passenger compartment of the aircraft so as to be rotated about the central inlet opening 18 at a vertical axis extending centrally through the aircraft. The upper surface portion 14 of the aircraft is arranged to have a suitable mass relative to the overall mass of the aircraft to provide a gyroscopic effect which stabilizes the aircraft in flight. For example, the rotating upper surface portion of the aircraft may be near or greater than 1/10^{th}, ¼ or ½ of the overall mass of the aircraft.

An engine 32 is centrally provided within the hollow interior of the body below the passenger compartment 22 to provide upward thrust and lift to the aircraft for vertical takeoff and sustained flight. An engine duct receives the engine 32 therein and communicates air from the inlet opening to the engine to be subsequently exhausted through the bottom side of the aircraft from the engine.

The engine duct includes a central portion 34 which communicates vertically through the aircraft including the passenger compartment 22 from the central inlet opening to a central exhaust opening 36 in the lower surface portion of the body of the aircraft. The engine 32 in this instance comprises a jet engine mounted in the vertical central portion of the engine duct to provide a downward exhaust through the central exhaust opening which provides upward thrust and lift to the aircraft body.

A primary steering mechanism 38 is mounted at the central exhaust opening 36 to redirect a portion of the thrust in a lateral direction to impart some horizontal movement to the aircraft in flight. The steering mechanism comprises a deflector panel 40 hinged at a top end at a periphery of the central portion of the engine duct so that a bottom end of the deflector panel can be laterally displaced into the path of the exhaust through the engine duct to the central exhaust opening. A linear actuator 42 is coupled to the bottom of the deflector panel for controlling the position thereof in a lateral direction to control the amount of thrust which is redirected in the lateral direction.

The deflector panel is supported on a circumferential support member 44 which extends about the central portion of the engine duct and which is rotatable in a circumferential direction about the duct to vary the position of the deflector panel 40 about the duct. Suitable controls are provided to control the angular position of the deflector panel in the circumferential direction about the duct to controllably vary the orientation which some of the thrust is redirected in the lateral direction to thus vary the orientation of lateral thrust being provided to the aircraft.

The engine duct further comprises an annular portion 46 which communicates through the annular space 26 between the passenger compartment and the upper surface portion of the body from the central inlet opening at the top of the body, through the openings in the collar 28 and the annular space 26 to an annular exhaust opening 48 at the bottom side of the aircraft in the lower surface portion 16.

The engine includes a pair of annular fan members 50 supported within the annular exhaust opening 28 one above the other for rotation about the central vertical axis of the aircraft. Each fan member 50 comprises a plurality of vanes 52 which extend generally radially outward across the annular exhaust opening at a plurality of circumferentially spaced positions thereabout. The vanes are oriented to provide downward thrust when the two fan members are counter-rotated, that is the two fans members are rotated in opposing directions relative to one another about the central vertical axis of the aircraft. The fan members 50 are driven to rotate through suitable gear sets 54 driven by the jet engine 32 in the central duct of the aircraft.

A secondary steering mechanism 56 is supported below the fan members 50 in the form of a plurality of rudders 58 which are typically supported in a vertical orientation for upward vertical thrust. The rudders 58 are provided in multiple different orientations and are supported for pivoting in multiple directions relative to the lower surface portion of the aircraft for redirecting downward exhaust from the fan members 50 into any one of plural different lateral directions to provide some controlled lateral thrust to the aircraft in a selected one of plural lateral directions if desired.

A fuel tank 60 is provided below the passenger compartment and above the annular fan members therebelow so as to be centrally located within the hollow interior of the aircraft body. The fuel tank is generally annular in shape about the central portion of the engine duct and is arranged to be fixed relative to the passenger compartment and the lower surface portion of the aircraft body.

A plurality of inner viewing panes 62 of transparent material are supported in the outer wall of the passenger compartment in which the panes are positioned adjacent one another in close proximity in a circular path extending circumferentially about the passenger compartment for viewing out from the passenger compartment in all directions. The inner viewing panes 62 are arranged to be aligned in elevation with a plurality of outer viewing panes 64 of transparent material formed in the outer surface portion of the aircraft body.

The outer viewing panes 64 are formed to be smooth and continuous with the exterior of the outer surface portion of the body so as to maintain the optimal aerodynamic shape of the exterior of the aircraft body. The outer viewing panes 64 are similarly provided in a circumferential pattern about the aircraft.

The width of the outer surface portion spanning between each adjacent pair of panes 64 in the circumferential direction may be near to the width of each of the panes in the circumferential direction without considerably limiting visibility from the passenger compartment as the outer viewing panes are rotatable with the outer surface portion relative to the passenger compartment so that the rotating outer viewing panes provide full visibility in all directions therethrough from the passenger compartment to the exterior of the aircraft.

In operation, the aircraft can take advantage of the exhaust from the jet engine 32 as well as the exhaust from the fan members 50 in various combinations to provide initial vertical thrust and lift to the aircraft body. The engine is also operated to drive rotation of the upper surface portion of the body for stability of the aircraft due to the gyroscopic effect of the mass of the upper surface portion when the aircraft is in flight. Either of the primary or secondary steering mechanisms or a combination thereof can be used to redirect some of the downward exhaust from the engine or fan members in a lateral direction to provide forward horizontal movement to the aircraft through the air relative to the ground.

The aerodynamic shape of the upper and lower surface portions of the body together function to provide some additional lift to the aircraft when displaced forwardly through the air in a horizontal direction so that once under sustained horizontal flight some of the downward exhaust from the fan members 50 or the jet engine may no longer be required to maintain altitude of the aircraft.

Throughout flight, the upper surface portion continues to rotate relative to the remaining portion of the aircraft for stability and to provide full visibility from the passenger compartment to the exterior of the aircraft. Downward visibility from the passenger compartment to the exterior of the aircraft may be provided by a plurality of cameras mounted on the lower surface portion of the body to capture images which are displayed to operators and passengers within the passenger compartment of the aircraft.

Access to the passenger compartment can be provided when the aircraft is stationary on the ground and the engines shutdown by persons either exiting through a suitable access door 66 in the central portion of the engine duct to exit through the inlet opening in the top side of the aircraft or by providing cooperating access panels in the outer wall of the passenger compartment and the upper surface portion of the aircraft body which can be aligned with one another when rotation of the upper surface portion of the body is stopped.

Turning now to FIG. 6, an alternative embodiment of the primary steering mechanism 38 is illustrated in which the jet engine 32 is mounted for vertical movement along a vertical track 70 within the central portion of the engine duct. In this manner the jet can be lowered downwardly through the central exhaust opening 36 at the bottom side of the aircraft. The jet engine 32 in this instance is further supported by a suitable pivot 72 which permits the engine to be pivoted about a generally horizontal axis on the vertical track so that the exhaust from the jet engine can be redirected from a downward vertical orientation to varying degrees of lateral offset to controllably vary an amount of exhaust redirection in a lateral direction to provide horizontal thrust to the aircraft. The track 70 upon which the jet engine is supported may also be supported on a circumferential support 44 which permits the lateral direction of thrust to be varied in multiple different orientations as in the previous embodiment.

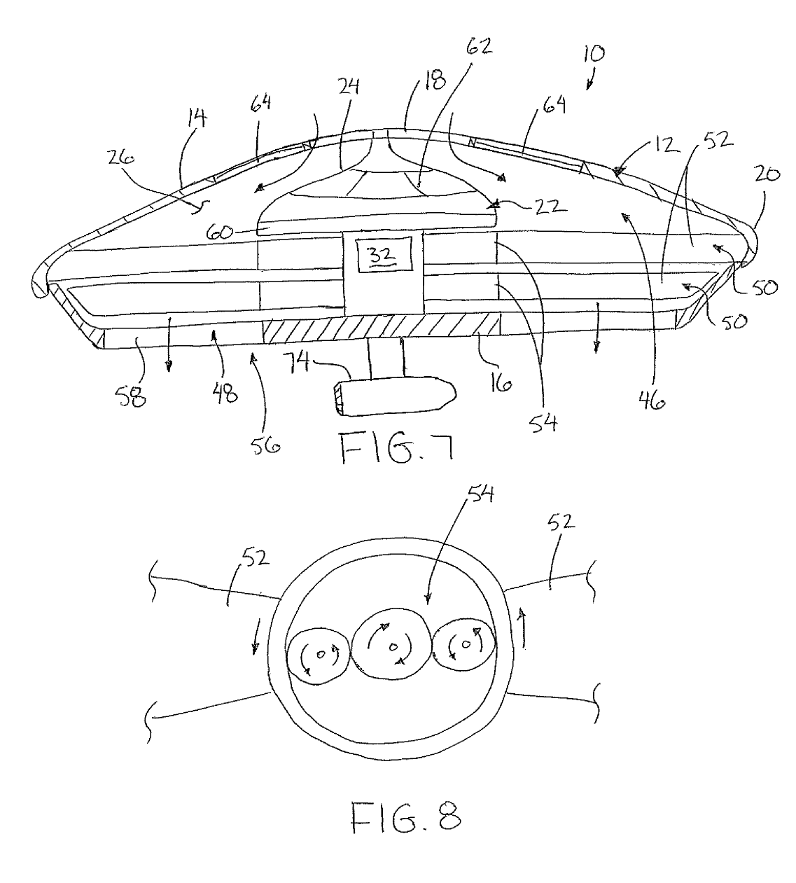

Turning now to FIGS. 7 and 8, a further embodiment of the aircraft is shown in which the upper surface portion 14 is substantially identical to the previous embodiment to be supported for rotation and including outer viewing panes therein, however the inlet opening in this instance communicates only with the annular space 26 between the passenger compartment and the upper surface portion as no central portion of the duct is provided extending through the passenger compartment. The engine 32 is thus used solely for driving rotation of the annular fan members 50 to provide upward thrust to the aircraft body. As shown in the schematic illustration of FIG. 7, the upper one of the fan members 50 can be coupled directly to the upper surface portion about the periphery thereof so that the upper fan member 50 and the upper surface portion are rotatable together about the central vertical axis of the aircraft while the lower fan is counter rotated in the opposing direction. As shown in FIG. 8, a suitable gear set 54 can be used in which a central gear is coupled to rotate with the upper one of the fan members 50 and serves to drive planetary gears to rotate the lower one of the fan members 50 in an opposite direction relative to the upper fan member.

An auxiliary engine 74 can be provided mounted centrally below the lower surface portion of the aircraft in the form of a jet engine oriented for providing thrust in a lateral direction. Orientation of the jet about the vertical axis can be controllably varied for steering the aircraft in addition to use of rudders 58 as in the previous embodiment.

In an alternative embodiment the rotation of the upper one of the fan members can be coupled to rotate in ratio to the upper surface portion of the body by a suitable gear set coupled therebetween.

In yet further embodiments of the aircraft, the annular space 26 between the passenger compartment and the upper surface portion of the body can be very small as the engine duct in this instance may comprise only the central portion communicating with the central exhaust opening 36 as described in the first embodiment. No fan members 50 or rudders associated with a second steering mechanism 56 are required in this instance as all thrust for vertical takeoff and landing is provided by the jet engine 32 in the central portion of the duct while additional lift during horizontal flight can be provided by the shape of the body of the aircraft itself. The configuration of the upper surface portion 14 to rotate with suitable mass to provide a gyroscopic effect on the aircraft remains identical to the previous embodiments along with the configuration of the outer viewing panes rotatable therewith to provide visibility for occupants of the passenger compartment. Various configurations of the primary steering mechanism 38 can be used when the engine duct only comprises a central portion locating the jet engine 32 therein.

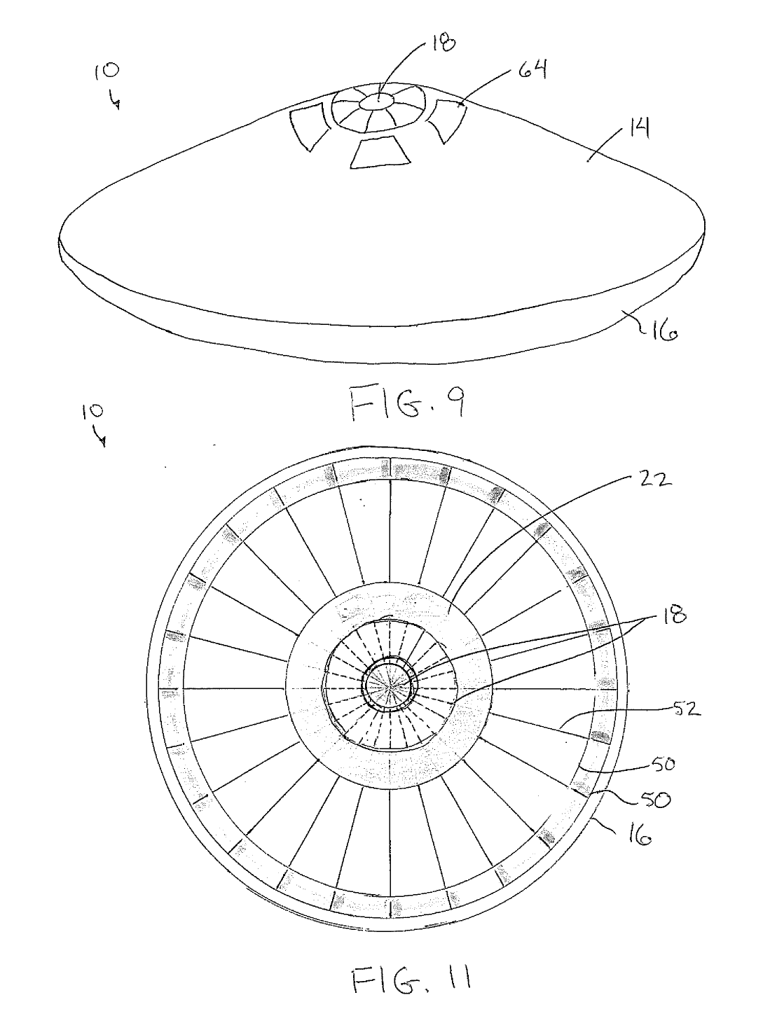

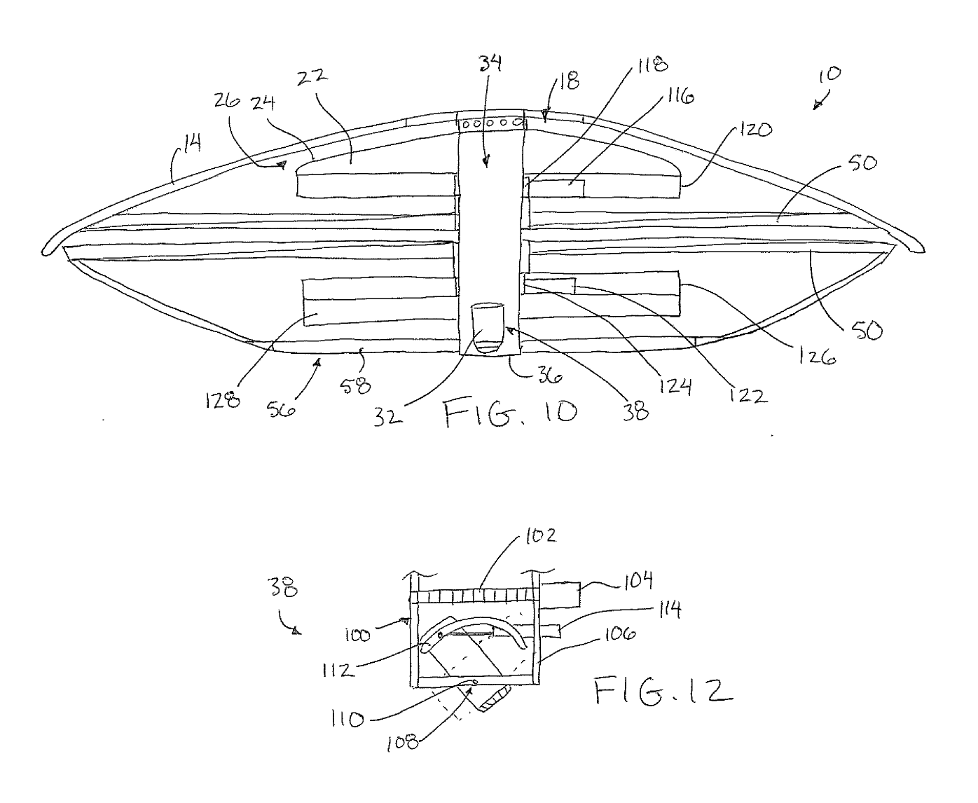

Turning now to FIGS. 9 through 13, a further embodiment of the aircraft 10 is shown which is substantially identical to the embodiment of FIGS. 1 through 4 with the exception of the configuration of the primary steering mechanism 38 and the manner in which the lower surface portion 16 is supported. More particularly in the embodiment of FIGS. 9 through 13, the lower surface portion 16 and the upper surface portion 14 are both supported to rotate relative to the components in the interior of the aircraft in opposing directions by independent drives.

The embodiment of FIGS. 9 through 13 is substantially identical to the first embodiment with regard to the overall shape and relationship between the upper and lower surface portions including the central inlet opening 18 in the top side thereof, the annular space 26 between the passenger compartment 22 and the upper surface portion 14, and the engine duct comprising both a central portion 34 and an annular portion 46 for communicating through a central exhaust opening 36 and an annular exhaust opening 48 in the lower surface portion respectively. Annular fan members 50 are again supported to rotate in communication with the annular exhaust opening 28 to provide steering by a secondary steering mechanism 56 formed of rudders 58. Furthermore, inner viewing panes 62 are again provided in the compartment 22 for alignment with outer viewing panes 64 in the upper surface portion of the body.

As best shown in FIGS. 10 and 12, the primary steering mechanism 38 again supports a jet engine 32: i) for rotation about a vertical axis to vary the direction of thrust provided by the jet; ii) for displacement in a vertical direction to selectively raise and lower the jet engine into and out of the interior of the body between the upper and lower surface portions; and iii) for pivotal movement about a horizontal axis to vary an inclination of the jet between horizontal and vertical to vary between providing vertical lift to the aircraft or providing horizontal thrust to the aircraft or any combination therebetween.

More particularly the primary steering mechanism in this instance comprises a frame 100 supported circumferentially about the jet engine and which is mounted on a suitable ring gear 102 about the central duct which is driven to rotate for rotating the frame 100 and the jet engine 32 supported thereon about the vertical axis under action of a suitable motor 104 at the periphery of the central duct.

The jet engine 32 is also supported on the frame 100 for movement along a vertical track 106 to raise and lower the jet engine in and out of the body of the aircraft. A pivot assembly 108 supports the jet engine 32 on the vertical track 106 so that in addition to raising and lowering the jet engine, the jet engine can be pivoted about the horizontal axis to vary its inclination between horizontal and vertical. The pivot assembly 108 includes a lower pivot 110 which pivotally couples an intermediate portion of the jet engine to the bottom end of the pivot assembly carried on the vertical track. An inner end of the jet engine is slidably received in an arc shaped track 112 which is curved about the lower pivot 110 so that as the inner end of the jet engine 32 is slidably displaced along the track 112, the jet engine is pivoted about the lower pivot 110 to vary its inclination through a range of approximately 180°, that is 90° from vertical to horizontal in each of two opposing direction. A hydraulic linear actuator 114 is coupled between the inner end of the jet engine and the frame supporting the arc shaped track 112 therein to control position and angular orientation of the jet engine about the horizontal pivot axis thereof by extension and contraction of the hydraulic linear actuator 114.

In the embodiment of FIGS. 9 through 12, the upper and lower surface portions are shaped and positioned relative to one another similarly to the first embodiment, however in this instance the surface portions are arranged to counter rotate relative to one another so that both surfaces rotate relative to the passenger compartment, as well as the engine duct and engine supported therein. The combined mass of the upper and lower surface portions is arranged to be a substantial portion of the overall mass of the aircraft so as to be suitable to provide a gyroscopic effect which stabilizes the aircraft in flight. For example the combined mass of the upper and lower surface portions of the aircraft may be near or greater than one tenth, one quarter or one half of the overall mass of the aircraft. Furthermore in the embodiment of FIGS. 9 through 12, the uppermost one of the fan members 50 is coupled to the upper surface portion for rotation together about the central portion of the engine duct while the lowermost fan member 50 and the lower surface portion are in turn coupled together for rotation about a vertical axis of the central portion of the engine duct in opposing directions.

More particularly an upper engine 116 is supported directly adjacent the bottom side of the crew cabin or passenger compartment at the periphery of the central portion of the engine duct for driving a respective upper ring gear 118 about the central duct which is coupled to the uppermost fan member 50 to drive rotation of both the upper fan member and the upper surface portion together. An upper fuel tank 120 extends circumferentially about the central duct directly below the crew compartment 22 to provide fuel to the upper engine 116 about which the fuel tank is supported. The upper engine 116, ring gear 118 and fuel tank 120 are supported generally in a common plane directly above the uppermost one of the fan members 50.

Similarly a lower engine 122 is supported at a periphery of the central duct through the aircraft for driving a respective lower ring gear 124 extending circumferentially about the central duct and which is coupled for rotation together with the lowermost one of the fan members 50 and the lower surface portion 16 of the body. A lower fuel tank 126 adjacent the lower engine 122 provides fuel to the lower engine. The lower fuel tank 126 extends circumferentially about the lower engine 122 and lower ring gear 124 so as to be situated in a generally common plane therewith directly below the lowermost one of the fan members 50.

A further jet fuel tank 128 is formed in a generally annular configuration about the central duct directly below the lower engine 122, lower ring gear 124 and lower fuel tank 126 to provide fuel to the jet engine 32 situated in the central portion of the engine duct in proximity to the jet fuel tank 128. The crew cabin 22, the upper fuel tank 120, the upper ring gear, the lower fuel tank 126, the lower ring gear, and the jet fuel tank 128 are all generally annular in shape about the central portion of the engine duct and are situated within the interior of the aircraft in a central vertical column to define the annular space 26 thereabout between the central column of the passenger compartment and fuel tanks and the outer peripheral edge 20 of the body of the aircraft.

Each of the fan members 50 includes a central portion in alignment with the vertical column of fuel tanks, and an outer portion where the vanes 52 are concentrated which extends outwardly beyond the periphery of the column of fuel tanks to the periphery of the aircraft body. The outer portion of the vanes 52 is in alignment with the annular space 26 through the interior of the aircraft body so that air drawn in through the central opening 118 is communicated through the annular space about the passenger compartment 22 and through the counter rotating fan members 50 prior to being exhausted through the annular exhaust opening in the bottom of the lower surface portion 16. At the annular exhaust opening, the rudders 58 of the secondary steering mechanism permit the thrust of the air driven by the fan members 50 to be partially redirected in a lateral direction for steering.

Each of the fan members is driven by its own engine with its own variable speed transmission. In addition to varying the thrust by varying the speed of the fan members, the speed of rotation of the upper and lower surface portions of the aircraft body will also vary, to vary the stability provided by the gyroscopic effect of the rotating components. A substantial portion of thrust and steering can be provided by the selected orientation of the jet engine 32. By tilting the jet engine in two opposed directions about the horizontal axis, thrust in two opposing directions can be provided. An electric motor 104 can be used to rotate the ring gear through a range of 90° in either direction so that the jet engine is also pivotal through a range of 180° about the vertical axis. The jet engine can thus be used to change direction or increase speed in any direction.

In addition to being used to provide air to the jet engine, the central portion of the engine duct also provides access to the interior of the aircraft. For example a small ladder may be provided from the inlet opening 18 to cooperating doors for the cabin compartment for crew entrance. A top door may also be provided for an emergency exit, perhaps with an additional escape capsule.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An aircraft comprising:
a main body comprising an upper surface portion spanning a top side of the main body generally radially outward from an inlet opening centrally located in the top side of the main body to a generally circular outer periphery of the main body and a lower surface portion spanning a bottom side of the main body opposite the upper surface portion;
a passenger compartment centrally located in the main body between the upper surface portion and the lower surface portion and being arranged to receive at least one passenger therein;
an engine duct communicating through the main body between the inlet opening centrally located in the upper surface portion of the main body above the passenger compartment and an exhaust opening in the lower surface portion of the main body; and
an engine supported in the engine duct in communication between the inlet opening and the exhaust opening and arranged to provide upward thrust to the main body;
the upper surface portion being supported for rotation relative to the passenger compartment and the engine; and
the upper surface portion of the main body having a suitable mass relative to the aircraft so as to be arranged to produce a gyroscopic effect on the aircraft.

2. The aircraft according to claim 1 wherein the exhaust opening comprises a central exhaust opening centrally located in the lower surface portion, the engine duct extends vertically between the inlet opening in the upper surface portion and the central exhaust opening in the lower surface portion, and the engine comprises a jet engine supported in the engine duct between the inlet opening and the central exhaust opening.

3. The aircraft according to claim 2 wherein there is provided a steering mechanism arranged to redirect exhaust from the engine exiting through the central exhaust opening.

4. The aircraft according to claim 3 wherein the steering mechanism comprises an actuator arranged to redirect a portion of the exhaust through the central exhaust opening in a lateral direction.

5. The aircraft according to claim 4 wherein the actuator is supported for rotation in a circumferential direction about the central exhaust opening to vary orientation of the lateral direction relative to the passenger compartment.

6. The aircraft according to claim 1 wherein the upper surface portion and the lower surface portion are suitably shaped to produce lift when displaced through the air in a lateral direction.

7. The aircraft according to claim 1 wherein the exhaust opening comprises an annular exhaust opening, the engine comprises a pair of annular fan members supported for rotation in proximity to the exhaust opening, and the engine duct communicates through an annular space between the passenger compartment and the upper surface portion of the main body from the central inlet opening above the passenger compartment to the annular fan members below the passenger compartment.

8. The aircraft according to claim 7 wherein the engine includes a jet engine centrally supported on the main body and arranged to provide thrust in a lateral direction.

9. The aircraft according to claim 1 wherein:
the exhaust opening comprises:
a central exhaust opening centrally located in the lower surface portion; and
an annular exhaust opening about the central exhaust opening; and
the engine comprises:
a jet engine supported in a central portion of the engine duct between the inlet opening and the central exhaust opening; and
a pair of annular fan members supported for rotation in proximity to the exhaust opening and arranged for communication through an annular portion of the engine duct comprising an annular space between the passenger compartment and the upper surface portion of the main body from the central inlet opening above the passenger compartment to the annular fan members below the passenger compartment.

10. The aircraft according to claim 1 wherein the upper surface portion includes a plurality of viewing panes therein arranged to provide visibility therethrough from the passenger compartment to an exterior of the main body.

11. The aircraft according to claim 10 wherein there is provided an outer wall surrounding the passenger compartment in fixed relation to the passenger compartment, the outer wall including a plurality of viewing panes supported therein, the viewing panes in the outer wall being arranged for alignment with the viewing panes in the upper surface portion of the main body as the upper surface portion of the main body is rotated.

12. The aircraft according to claim 10 wherein there is provided a fuel tank supported centrally on the main body below the passenger compartment in fixed relation to the passenger compartment, the fuel tank being arranged to provide fuel to the engine.

13. The aircraft according to claim 1 wherein the lower surface portion of the housing is arranged to rotate relative to the passenger compartment in an opposing direction relative to the upper surface portion.

14. An aircraft comprising:
a main body comprising an upper surface portion spanning a top side of the main body generally radially outward from an inlet opening centrally located in the top side of the main body to a generally circular outer periphery of the main body and a lower surface portion spanning a bottom side of the main body opposite the upper surface portion;
a passenger compartment centrally located in the main body between the upper surface portion and the lower surface portion and being arranged to receive at least one passenger therein;
an engine duct communicating through the main body between the inlet opening centrally located in the upper surface portion of the main body above the passenger compartment and an exhaust opening in the lower surface portion of the main body; and
an engine supported in the engine duct in communication between the inlet opening and the exhaust opening and arranged to provide upward thrust to the main body;
the upper surface portion including a plurality of viewing panes therein arranged to provide visibility therethrough from the passenger compartment to an exterior of the main body; and
the upper surface portion being supported for rotation relative to the passenger compartment and the engine.

15. The aircraft according to claim 14 wherein the upper surface portion of the main body has a suitable mass relative to the aircraft to produce a gyroscopic effect on the aircraft.

16. The aircraft according to claim 14 wherein the upper surface portion and the lower surface portion are suitably shaped to produce lift when displaced through the air in a lateral direction.

17. The aircraft according to claim 14 wherein there is provided an outer wall surrounding the passenger compartment in fixed relation to the passenger compartment, the outer wall including a plurality of viewing panes supported therein, the viewing panes in the outer wall being arranged for alignment with the viewing panes in the upper surface portion of the main body as the upper surface portion of the main body is rotated.

18. The aircraft according to claim 14 wherein there is provided a fuel tank supported centrally on the main body below the passenger compartment in fixed relation to the passenger compartment, the fuel tank being arranged to provide fuel to the engine.

19. The aircraft according to claim 14 wherein the plurality of viewing panes are circumferentially spaced about the inlet opening and wherein the upper surface portion between adjacent ones of the viewing panes is near in width in the circumferential direction to a width of the viewing panes in the circumferential direction.

20. The aircraft according to claim 14 wherein the lower surface portion of the housing is arranged to rotate relative to the passenger compartment in an opposing direction relative to the upper surface portion.
